(19) United States
(12) Patent Application Publication
(10) Pub. No.: US 2004/0044710 A1
(43) Pub. Date: Mar. 4, 2004

(54) Converting mathematical functions to power series

(76) Inventors: John R. Harrison, Beaverton, OR (US); Ping T. Tang, Hayward, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/229,448

(22) Filed: Aug. 28, 2002

(51) Int. Cl. G06F 7/00

(52) U.S. Cl. 708/200

(57) ABSTRACT

A processor based system may convert a mathematical function to a power series converging on that function. One or more sets of coefficients for the power series may be pre-computed and stored in machine readable storage medium. In response to a request to execute the mathematical function, the processor obtains coefficients of the terms of the power series from storage and sums up the terms.

### BACKGROUND

This invention relates to processor-based systems that perform arithmetic and mathematical operations.

Modern processor-based systems include processors that execute a variety of arithmetic and other mathematical operations. For example, one or more arithmetic logic units and/or floating point math units in a processor may execute arithmetic and mathematical operations. In many processor-based systems, the speed of arithmetic or mathematical operations may be a bottleneck to performance. To reduce or minimize this bottleneck for arithmetic and mathematical operations, some processor-based systems may store pre-computed values for certain mathematical functions as a lookup table in memory or other machine readable storage medium, and execute a function using a pre-computed value.

For example, a processor may obtain one or more pre-computed values from a lookup table in memory, and interpolate the answer to a mathematical function from the pre-computed value(s) using a reconstruction equation. For example, a processor may execute the function sin(x) for a floating point number x by accessing a table in memory or other machine readable storage medium to find and select a value A which is close to the variable x. For example, the value r=A−x may be minimized. In the table, each value for A may be evenly spaced at some distance B, so A=nB. For example, B may be n/32 for the sin function. The processor may retrieve values for the functions sin(A) and cos(A) from the table in memory or other machine readable storage medium. The processor may calculate the answer to a reconstruction equation such as: sin(x)=sin(A)+sin(A) [cos(r)−1]+cos(A)sin(r), where r=x−A.

With breakpoints a distance B apart, |r|≦B/2. If the bound is reasonably small, for example on the order of 2⁻⁵, the processor may calculate the functions sin(r) and cos(r)−1 using polynomials with relatively few terms.

Accordingly, a processor based system may execute a mathematical function by obtaining one or more pre-computed values from a table in memory, and interpolating the answer with a suitable reconstruction equation.

The processor time for executing some mathematical functions, however, cannot be reduced substantially or significantly through use of a table and reconstruction equation. For example, some functions and/or reconstruction equations involve division of floating point numbers. One such example is the reconstruction equation for the tangent function. Other examples include the arcsine and arccosine functions. In modern processor based systems, division of floating point numbers takes more processor execution time than multiplication or addition. A need exists for faster execution by processor based systems of some mathematical functions and reconstruction equations on floating point numbers.

### BRIEF DESCRIPTION OF THE DRAWINGS

FIG. 1 is a block diagram of an example processor based system according to one embodiment of the present invention.

FIG. 2 is a schematic diagram of a table according to one embodiment of the invention.

FIG. 3 is a flow chart of an execution of the invention according to one embodiment.

### DETAILED DESCRIPTION

In one embodiment of the invention, a processor based system computes and stores a plurality of different sets of coefficients for polynomials of a power series that converges on a specified mathematical function. A power series is an equation having the general form: a₀+a₁x+a₂x²+a₃x³+a₄x⁴+ . . . A power series, which is an infinite sum of the product of certain numbers aₙ and powers of the variable x, may be characterized as converging on a specified mathematical function.

The numbers aₙ in a power series are called coefficients. Slightly more general, an equation of the form: a₀+a₁(x−x₀)+a₂(x−x₀)²+a₃(x−x₀)³+a₄(x−x₀)⁴+ . . . is called a power series with center x₀. In one embodiment of the invention, a polynomial and set of coefficients may be computed and stored for breakpoints in the range of possible values for the variable x.

One embodiment of the invention includes a processor based system that computes and stores one or more sets of values for the coefficients in the reconstruction equation for a mathematical function such as the tangent function, the arcsine function, or the arccosine function. The reconstruction equations for each of these functions may be converted to a power series. In one embodiment, the reconstruction equation for a mathematical function f(x) may be converted to an equation having the form: f(x)=f(A)+f′(A)r+f″(A)r²/2+ . . . , where r=x−A. The coefficients for this power series are f(A), f′(A) and f″(A)/2, etc. for each of the possible values of the variable A.

One embodiment of the invention may be implemented in software for execution by a processor based system configured with a suitable combination of hardware devices. The machine readable storage medium may include, but is not limited to, any type of disk including floppy disks, optical disks, CD-ROMs, CD-RWs, and magneto-optical disks, semiconductor devices such as ROMs, RAMs, EPROMs, EEPROMs, magnetic or optical cards, or any type of media suitable for storing electronic information. Similarly, embodiments may be implemented as software modules executed by a programmable control device. A programmable control device may be a computer processor or a custom designed state machine. Custom designed state machines may be embodied in a hardware device such as a printed circuit board having discrete logic, integrated circuits, or specially designed application specific integrated circuits (ASICs).

One or more embodiments of the invention may be implemented in hardware or firmware in a processor based system. For example, the invention may be implemented in the hardware or firmware of a processor, and specifically in an arithmetic logic unit of floating point math unit of a processor.

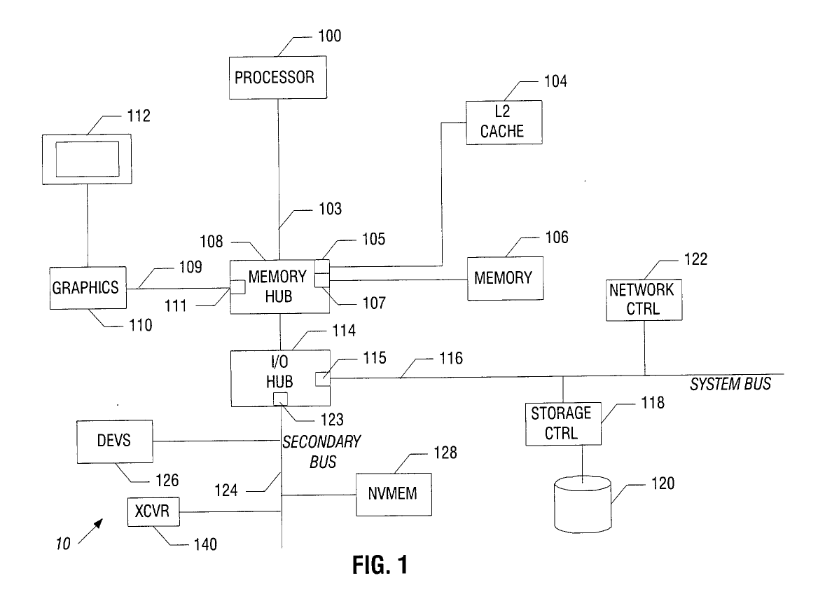

Referring to FIG. 1, in one embodiment, a system 10 includes processor 100, which may be a general-purpose or special-purpose processor such as a microprocessor, microcontroller, an application-specific integrated circuit (ASIC), a programmable gate array (PGA), and the like. The processor 100 may be coupled over a host bus 103 to a memory hub 108 in one embodiment, which may include a memory controller 107 coupled to a main memory 106. In addition, the memory hub 108 may include cache controller 105 coupled to an L2 cache 104. The memory hub 108 may also include a graphics interface 111 that is coupled over a link 109 to a graphics controller 110, which in turn may be coupled to a display 112. As an example, the graphics interface 111 may conform to the Accelerated Graphics Port (A.G.P.) Interface Specification, Revision 2.0, dated in May 1998.

The memory hub 108 may also be coupled to an input/output (I/O) hub 114 that includes bridge controllers 115 and 123 coupled to a system bus 116 and a secondary bus 124, respectively. As an example, the system bus may be a Peripheral Component Interconnect (PCI) bus, as defined by the PCI Local Bus Specification, Production Version, Revision 2.1 dated in June 1995. The system bus 116 may be coupled to a storage controller 118 that controls access to one or more storage devices 120, such as a hard disk drive, a compact disc (CD) drive, or a digital video disc (DVD) drive. Other storage media may also be included in the system.

In an alternative embodiment, the storage controller 118 may be integrated into the I/O hub 114, as may other control functions. The system bus 116 may also be coupled to other components including, for example, a network controller 122 that is coupled to a network port (not shown).

Additional devices 126 may be coupled to the secondary bus 124, such as an input/output control circuit coupled to a parallel port, serial port, and/or floppy disk drive. A non-volatile memory 128 may also be coupled to the secondary bus 124. Further, a transceiver 140, which may include a modem or a wireless communications chip, as examples, may also be coupled to the secondary bus.

Although the description makes reference to specific components of the system 10, it is contemplated that numerous modifications and variations of the described and illustrated embodiments may be possible. For example, instead of memory and I/O hubs, a host bridge controller and system bridge controller may provide equivalent functions, with the host bridge controller coupled between the processor 100 and system bus 116, and the system bridge controller 123 coupled between the system bus 116 and the secondary bus 124. In addition, any of a number of bus protocols may be implemented.

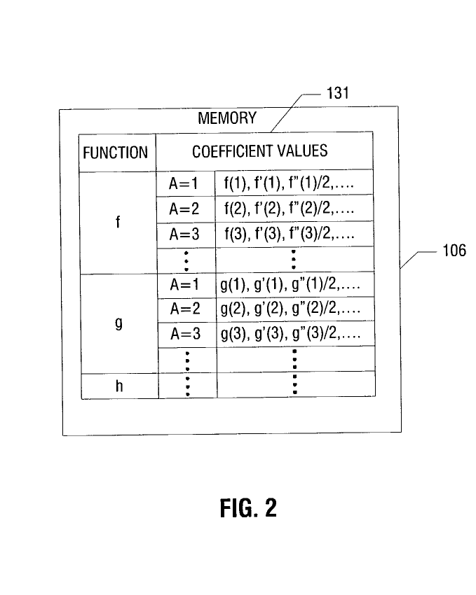

FIG. 2 shows one embodiment of the invention, in which several sets of polynomial coefficients for variable A in mathematical functions f, g, h, etc. are stored as table 131 in memory 106. Thus, A is a numeric value of a variable in a specified mathematical function. For each stored value of A for that function, one or more sets of coefficients of a power series converging on that function may be stored.

For example, for a mathematical function f, table 131 in FIG. 2 lists a first set of coefficients for A=1. These coefficients for the power series may be f(1), f′(1), f″(1)/2, etc. Similarly, if A=2, the coefficients for the power series may be f(2), f′(2), f″(2)/2, etc. Similarly, for mathematical function g, table 131 lists a set of coefficients for A=1, 2, 3 etc.

In one embodiment of the invention, a processor based system converts a mathematical function to a power series converging on that function. A plurality of sets of numeric values for coefficients in the power series may be computed and stored in memory or other machine readable storage. Multiple sets of coefficients may be computed and stored for one or more variables in the mathematical function. Thus, in one embodiment of the invention, one or more sets of numeric values for the coefficients in a power series may be computed and stored in memory, with each set corresponding to a numeric value of a variable in a mathematical function.

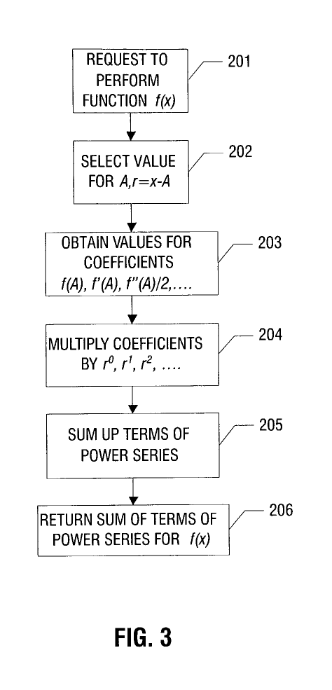

FIG. 3 shows a flowchart according to one embodiment of the invention for a processor based system to perform a mathematical function by converting a reconstruction equation for the function to a power series. In this embodiment, in block 201, a command or instruction is received to perform a specified mathematical function f(x). In block 202, according to one embodiment of the invention, a numeric value of A may be selected from a table in computer memory or other machine readable storage medium. In this embodiment, the value of A may be selected by minimizing the value of r=x−A.

In block 203, once a numeric value for A is selected, a set of numeric values for the polynomial coefficients f(A), f′(A), f″(A)/2, etc. may be obtained from a stored table. In one embodiment, one or more sets of numeric values for these coefficients may be pre-computed and stored in memory or other machine readable storage. For example, if A=1, a set of numeric values for f(1), f′(1), f″(1)/2, etc. may be pre-computed and stored. For A=2, another set of numeric values may be pre-computed and stored, i.e., f(2), f′(2), f″(2)/2. If the set of numeric values for the coefficients are not pre-computed and stored, after the value of A is determined, the processor may compute a set of numeric values for the coefficients.

In one embodiment of the invention, in block 204, the processor may calculate each of the terms of the power series by multiplying the numeric value of each coefficient (obtained in block 203) with the numeric value r⁰, r¹, r², etc. for that term. Thus, the processor may calculate the terms of the power series by multiplying each numeric value for f(A), f′(A), f″(A)/2, etc. with the corresponding numeric value for r⁰, r¹, r², etc. In block 205, the processor may sum up a plurality of the terms of the power series. In block 206, the sum of the terms of the power series is returned for f(x).

In one embodiment of the invention, each mathematical function stores as a table N different entries for each value of A, and each entry has k different polynomial coefficients. Thus, a table may have Nk polynomial coefficients. One embodiment of the invention contemplates summing up a finite number of terms of the power series, and the overall accuracy of the computation depends on the number of terms summed up, as well as the number of pre-computed values for A.

In one embodiment of the invention, certain terms in the power series may include the slope σ of the specified mathematical function. The slope σ may be pre-computed and stored for each pre-computed and stored value of variable A. This embodiment may be particularly useful for mathematical functions having a slope σ that is close to a power of 2 at x=0. In other words, |σ|=±2^{α} for some integer α. When the slope is included, the power series has the general form:

f(x)=(f(A)+σr)+(f′(A)−σ)r+f″(A)r²/2+ . . .

In this embodiment, the first two terms, f(A) and σr, constitute the dominant part of the final answer of the above power series, even for small x. At the low end, |(f′(A)−σ)r| is much less than |σr|, while at the high end, f(A) is large enough to dominate the answer. The processor based system may compute σr without rounding error because |σ| is a power of 2, and may determine f(A)+σr accurately by accessing the values for f(A) stored as a lookup table.

A specific example of one embodiment of the invention is a processor based system for calculating the tangent function tan(x). The tangent function has the following reconstruction equation:

$$tan ( x ) = \frac{tan ( A ) + tan ( r )}{1 - tan ( A ) tan ( r )}$$

$$where r = x - A .$$

The reconstruction equation for the tangent function may be converted to the power series:

tan(x)=tan(A)+tan′(A)r+tan″(A)r²/2+ . . .

This power series may be characterized as converging on the reconstruction equation for the tangent function. In this example, tan(A), tan′(A) and tan″(A)/2, etc. define a set of coefficients for each of the possible values of the variable A. One or more sets of these coefficients may be pre-computed and stored as a table.

Along with the coefficients listed above, the slope σ for each value of A for the reconstruction equation for the tangent function may be stored as a table. Including the slope σ may be useful if the input x is near even multiples of n/2. Thus, the slope a of the tangent function may be pre-computed and stored for each value of A. If so, the following tangent function may be written and executed:

tan(x)=(tan(A)+σr)+(tan′(A)−σ)r+tan″(A)r²/2+ . . .

If the input x for the tangent function is near odd multiples of n/2, however, the tangent function may be converted to an equation having the following form: 1/(x−(2n+1)n/2), where n is any integer.

Embodiments of the present invention may reduce or minimize the time to execute certain arithmetic and mathematical operations, improving the overall performance of a processor based system.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
obtaining from a machine readable storage medium a set of numeric values for coefficients of a power series that converges on a specified mathematical function;
calculating a plurality of terms of the power series using the set of numeric values; and
returning a sum of the plurality of the terms of the power series for the specified mathematical function.

2. The method of claim 1 further comprising storing in the machine readable storage medium the set of numeric values for coefficients of the power series.

3. The method of claim 1, wherein the specified mathematical function is the tangent function.

4. The method of claim 1, wherein the specified mathematical function is the arcsine function.

5. The method of claim 1, wherein the specified mathematical function is the arccosine function.

6. The method of claim 1, wherein the specified mathematical function is a reconstruction equation for interpolating an answer to a second mathematical function.

7. A method comprising:
pre-computing a plurality of sets of coefficients for a power series converging on a reconstruction equation for a specified mathematical function; and
storing the plurality of sets of coefficients in a machine readable storage medium.

8. The method of claim 7, wherein the specified mathematical function is the tangent function.

9. A system, comprising:
memory for storing sets of coefficients for a plurality of terms of a power series converging on a specified mathematical function; and
a processor to sum up the plurality of terms of the power series and return the sum of the terms for the specified mathematical function.

10. The system of claim 9, wherein the specified mathematical function is the tangent function.

11. The system of claim 9 wherein the processor includes a floating point math unit.

12. The system of claim 9 wherein the processor includes at least one arithmetic logic unit.

13. An article including a machine-readable storage medium containing instructions that if executed cause a system to:
store a set of coefficients for terms of a power series that converges on a specified mathematical function; and
in response to a request to execute the specified mathematical function, retrieve the stored set of coefficients for terms of the power series and sum up the terms using the stored set of coefficients.

14. The article of claim 13 wherein the specified mathematical function is a reconstruction equation for a second mathematical function.

15. The article of claim 13 wherein the specified mathematical function is a reconstruction equation for the tangent function.

16. The article of claim 13 wherein the specified mathematical function is a reconstruction equation for the arcsine function.

17. The article of claim 13 wherein the specified mathematical function is a reconstruction equation for the arccosine function.

18. The article of claim 13 wherein the machine-readable storage medium stores a plurality of sets of coefficients for the terms of the power series.

19. The article of claim 13 wherein the coefficients for the terms of the power series are stored as a lookup table in the machine-readable storage medium.

21. The article of claim 14 wherein coefficients for the terms of a plurality of mathematical functions are stored in the machine-readable storage medium.
